(19) United States
(12) Patent Application Publication
(10) Pub. No.: US 2020/0252585 A1
(43) Pub. Date: Aug. 6, 2020

(54) Systems, Algorithms, and Designs for See-through Experiences With Wide-Angle Cameras

(71) Applicant: Shijian Tech (Hangzhou) Ltd., Hangzhou (CN)

(72) Inventor: Changyin Zhou, San Jose, CA (US)

(21) Appl. No.: 16/782,979

(22) Filed: Feb. 5, 2020

Related U.S. Application Data
(60) Provisional application No. 62/801,318, filed on Feb. 5, 2019.

(51) Int. Cl. H04N 7/14; H04N 5/232

(52) U.S. Cl. CPC H04N 7/144; H04N 5/23299; H04N 5/23216; H04N 5/23238; H04N 7/147

(57) ABSTRACT

The present disclosure relates to methods and systems for providing a visual teleport window. An example system includes a wide-angle camera, a display, and a controller. The controller includes at least one processor and a memory. The at least one processor executes instructions stored in the memory so as to carry out operations. The operations include receiving remote viewport information. The viewport information is indicative of a relative location of at least one eye of a remote user with respect to a remote display. The operations also include causing the wide-angle camera to capture an image of an environment of the system. The operations additionally include, based on the viewport information and information about the remote display, cropping and projecting the image to form a frame. The operations also include transmitting the frame for display at the remote display.

### CROSS-REFERENCE TO RELATED APPLICATIONS

The present application is a patent application claiming priority to U.S. Patent Application No. 62/801,318 filed Feb. 5, 2019, the contents of which are hereby incorporated by reference.

### BACKGROUND

Conventional video conferencing systems include a camera and a microphone at two physically-separate locations. A participant of a conventional video conference can typically see a video image and audio transmitted from the other location. In some instances, a given camera can be controlled by one or both participants using pan, tilt, zoom (PTZ) controls.

However, participants in a conventional video conference do not feel as if they are physically in the same room (at the other location). Accordingly, a need exists for communication systems and methods that provide realistic video conference experience.

### SUMMARY

Systems and methods disclosed herein relate to a visual “teleport” window that may provide a viewer with a viewing experience of looking at a place in another location as if the viewer were looking through a physical window. Similarly, the systems and methods could provide two persons in two rooms at different locations to see each other, and interact with one another, as if through a physical window.

In an aspect, a system is provided. The system includes a local viewport and a controller. The local viewport includes a camera and a display. The controller includes at least one processor and a memory. The at least one processor executes instructions stored in the memory so as to carry out operations. The operations include receiving remote viewport information. The viewport information is indicative of a relative location of at least one eye of a remote user with respect to a remote display. The operations also include causing the camera to capture an image of an environment of the local viewport. The operations additionally include, based on the viewport information and information about the remote display, cropping and projecting the image to form a frame. The operations yet further include transmitting the frame for display at the remote display.

In another aspect, a system is provided. The system includes a first viewing window and a second viewing window. The first viewing window includes a first camera configured to capture an image of a first user. The first viewing window also includes a first display and a first controller. The second viewing window includes a second camera configured to capture an image of a second user. The second viewing window also includes a second display and a second controller. The first controller and the second controller are communicatively coupled by way of a network. The first controller and the second controller each include at least one processor and a memory. The at least one processor executes instructions stored in the memory so as to carry out operations. The operations include determining first viewport information based on an eye position of the first user with respect to the first display. The operations also include determining second viewport information based on an eye position of the second user with respect to the second display.

In another aspect, a method is provided. The method includes receiving, from a remote viewing window, remote viewport information. The remote viewport information is indicative of a relative location of at least one eye of a remote user with respect to a remote display. The method includes causing a camera of a local viewing window to capture an image of an environment of the local viewing window. The method yet further includes, based on the remote viewport information and information about the remote display, cropping and projecting the image to form a frame. The method also includes transmitting the frame for display at the remote display.

In another aspect, a method is provided. The method includes causing a first camera to capture an image of a first user. The method also includes determining, based on the captured image, first viewport information. The first viewport information is indicative of a relative location of at least one eye of the first user with respect to a first display. The method also includes transmitting, from a first controller, the first viewport information to a second controller. The method yet further includes receiving, from the second controller, at least one frame captured by a second camera. The at least one frame captured by the second camera is cropped and projected based on the first viewport information. The method also includes displaying, on a first display, the at least one frame.

In another aspect, a system is provided. The system includes various means for carrying out the operations of the other respective aspects described herein.

These as well as other embodiments, aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE FIGURES

FIG. 1A illustrates a scenario with viewers observing 3D imagery presented with a head-coupled perspective (HCP), according to an example embodiment.

FIG. 1B illustrates a scenario with a telexistence operator and a surrogate robot, according to an example embodiment.

FIG. 1C illustrates a 360° virtual reality camera and a viewer with a virtual reality headset, according to an example embodiment.

FIG. 1D illustrates a telepresence conference, according to an example embodiment.

FIG. 2 illustrates a system, according to an example embodiment.

FIG. 3A illustrates a system, according to an example embodiment.

FIG. 3B illustrates a system, according to an example embodiment.

FIG. 4 is a diagram of an information flow, according to an example embodiment.

FIG. 5A is a diagram of an information flow, according to an example embodiment.

FIG. 5B is a diagram of an information flow, according to an example embodiment.

FIG. 6 illustrates a system, according to an example embodiment.

FIG. 7 illustrates a method, according to an example embodiment.

FIG. 8 illustrates a method, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### I. Overview

Systems and methods described herein relate to a visual teleport window that allows one person to experience (e.g., observe and hear) a place in another location as if through an open physical window. Some embodiments may allow two persons at different locations see each other as if looking through such a physical window. By physically moving around the window, near or far, one person can see different angles of areas in a field of view of other location, and vice versa. The teleport window system includes one regular display, one wide-angle camera, and a computer system, at each physical location. In some embodiments, a plurality of cameras (e.g., a wide-angle camera and multiple narrow-angle/telephoto cameras) could be utilized with various system and method embodiments. As an example, if multiple cameras are used, a view interpolation algorithm may be used to synthesize a view from a particular view point (e.g., the center of the display) using image information from the multiple camera views and/or based on the cameras' relative spatial arrangement. The view interpolation algorithm could include a stereo vision interpolation algorithm, a pixel segmentation/reconstruction algorithm, or another type of multiple camera interpolation algorithm. The system and method may utilize hardware and software algorithms that are configured to maintain real-time rendering so as to make the virtual window experience as realistic as possible. Various system and method embodiments are described herein, which may improve communications and interactions between users by simulating an experience of interacting by way of an open window or virtual portal.

### II. Comparison to Conventional Approaches

A. Head-Coupled Perspective (HCP)

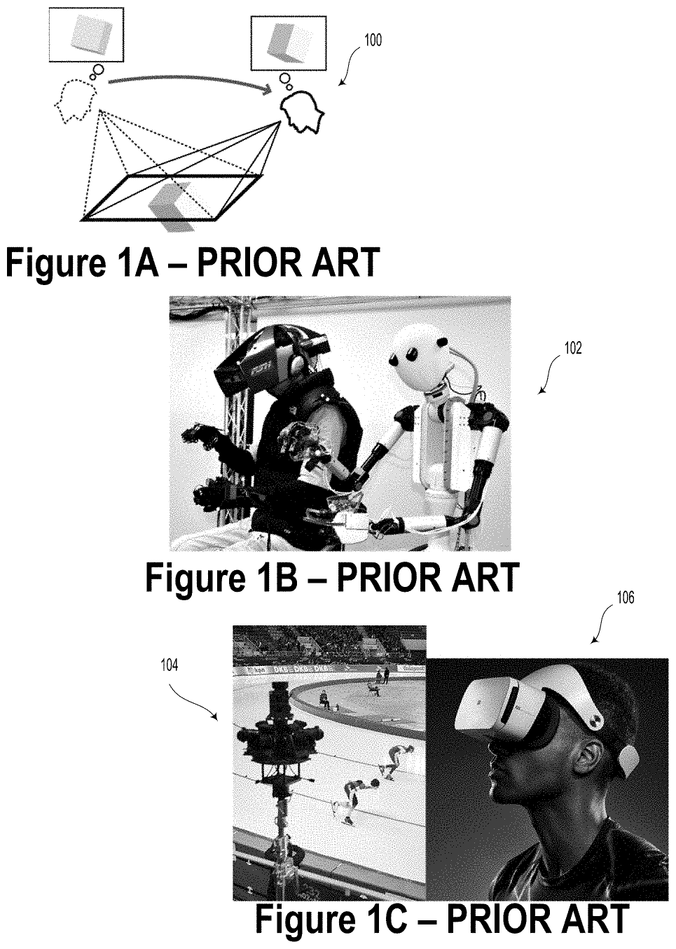

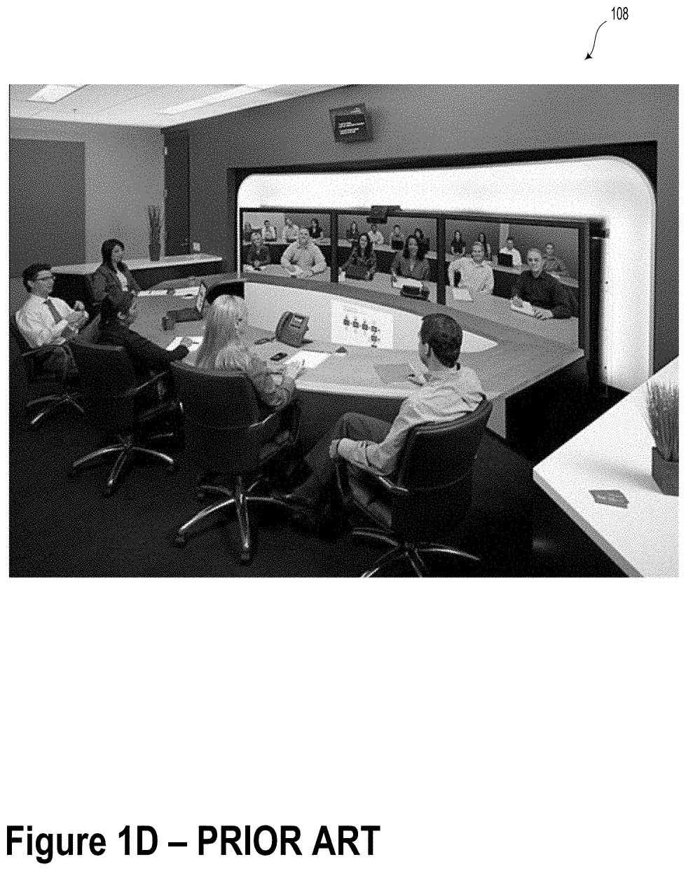

Head-coupled perspective is a way to display 3D imagery on 2D display devices. FIG. 1A illustrates a scenario 100 with viewers observing 3D imagery presented with a head-coupled perspective (HCP), according to an example embodiment. The perspective of the scene on the 2D screen is based on the position of the respective user's eyes, simulating a 3D environment. When a user moves their head, the perspective of the 3D scene changes, creating the effect of looking through a window toward the scene, instead of looking at a flat projection of a scene.

In the present systems and methods described herein, instead of displaying 3D imagery, the user's eye gaze position and/or head position can be utilized to control a wide-angle camera and/or images from the wide-angle camera at the other physical location. Furthermore, the present system couples multiple display and capture systems from a plurality of physical locations together to enable a see-through and face-to-face communication experience.

B. Telexistence

Telexistence enables a human being to have a real-time sensation of being at a place other than where he or she actually exists, and being able to interact with the remote environment, which may be real, virtual, or a combination of both. Telexistence also refers to an advanced type of teleoperation system that enables an operator to perform remote tasks dexterously with the feeling of existing in a surrogate robot working in a remote environment. FIG. 1B illustrates a scenario 102 with a telexistence operator and a surrogate robot, according to an example embodiment.

C. 360° VR Live Streaming

360° VR live streaming includes capturing videos or still images using one or more 360° VR cameras at the event location. The 360° VR video signals can be live streamed to a viewer at a different location. The viewer may wear a VR headset to watch the event as if he or she is at the position of the VR camera(s) at the event location. FIG. 1C illustrates a 360° virtual reality camera and a viewer with a virtual reality headset, according to an example embodiment.

The 360° VR live streaming approach is usually implemented with uni-directional information flow. That is, 360° video is transmitted to the viewer's location only. Even if another VR camera is set up to transmit live stream content in the opposite direction simultaneously, the experience is often not satisfactory at least because the viewer is wearing a VR headset, which is not convenient and also blocks the user's face in the transmitted live stream.

D. Telepresence Conference

In other conventional telepresence conferences, the physical arrangement of furniture, displays, and cameras can adjusted in a way that meeting participants feel all participants are in one room. However, such systems can require a complicated hardware setup as well as require inflexible room furniture arrangements. FIG. 1D illustrates a conventional telepresence conference 108, according to an example embodiment.

E. Tracking-Based Video Conference

In some cases, video conference systems can track objects (e.g. a person) and then apply digital (or optical) zoom (or panning), so that people are automatically maintained within the displayed image at the opposite side.

### III. Example Systems

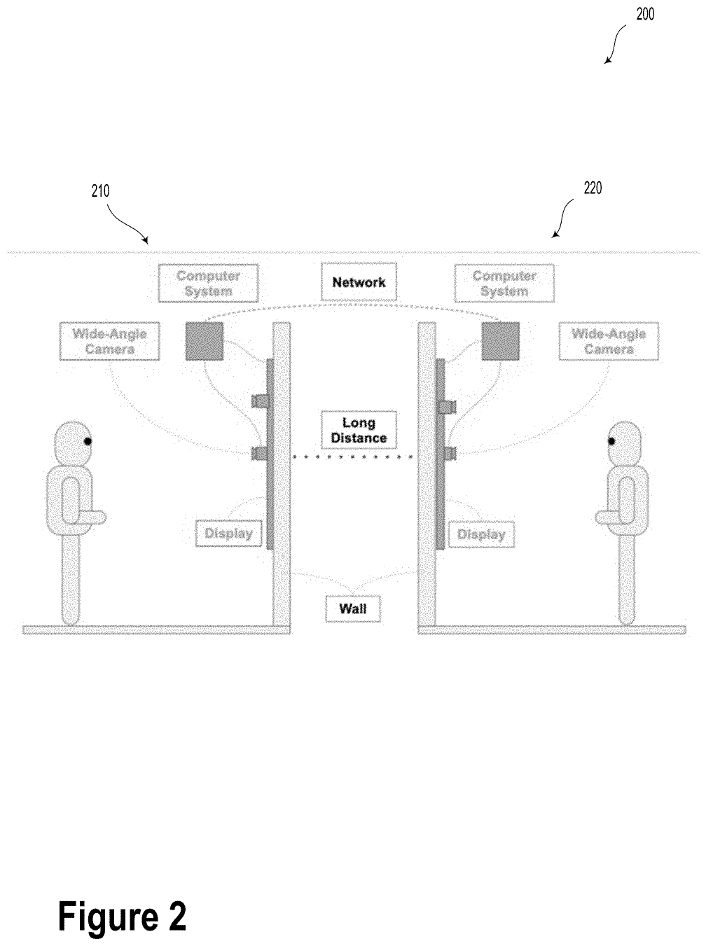

FIG. 2 illustrates a system 200, according to an example embodiment. The system 200 could be described as a visual teleport window (VTW). The VTW system connects people at two different physical locations. At each physical location, a respective portion of system 200 includes a wide-angle camera, a display, and a computer system. The wide-angle camera may be connected to the computer system via WiFi connection, USB, Bluetooth, SDI, HDMI, or MIPI lanes. A wired connection between the wide-angle camera and the computer system is also contemplated and possible. In some embodiments, the wide-angle camera could provide a field of view of between 120° to 180° (in azimuth and/or elevation angle). However, other types of cameras, including pan-tilt-zoom (PTZ) cameras and/or 360° VR cameras are possible and contemplated. As described elsewhere herein, the system 200 could additionally or alternatively include a plurality of cameras, which could include wide-angle cameras and/or narrow-angle cameras (e.g., having telephoto or zoom lenses). As an example, the multiple cameras could be located along the left/right side of the display, along the top/bottom side of the display, at each of the four sides of the display, or at each of the four corners of the display, or at other locations relative to the display. In some embodiments, the camera or cameras could be located within the display area. For example, the display could include a wide screen display and one or more outward-facing cameras could be arranged within a display area of the wide screen display. Cameras with other fields of view and various relative spatial arrangements are contemplated and possible. The display may be connected to the computer system via Wireless cast or wires (e.g., HDMI). The computing systems of the two portions of system 200 are connected by way of a communication network (e.g., the Internet).

The two portions of VTW system 200 on the left and right sides of the FIG. 2 (e.g., viewing window 210 and viewing window 220) are connected via the network. Viewing window 210 (on Side A) sends its viewport information (e.g., view angle from the viewer's eyes on Side A to the visual window) to the viewing window 220 located on Side B. Viewing window 220 (at Side B) can capture and send back a corresponding frame (and/or video stream) based on the viewport information received from the first portion of the VTW system (at Side A). The frame can be displayed by the system at Side A and the viewer will have an impression of looking through a window into the environment of Side B.

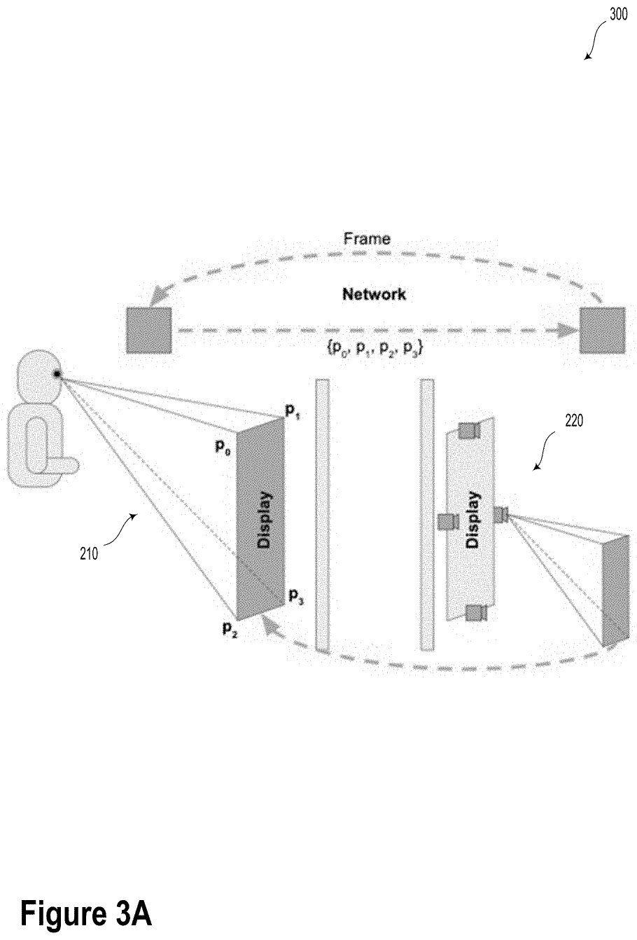

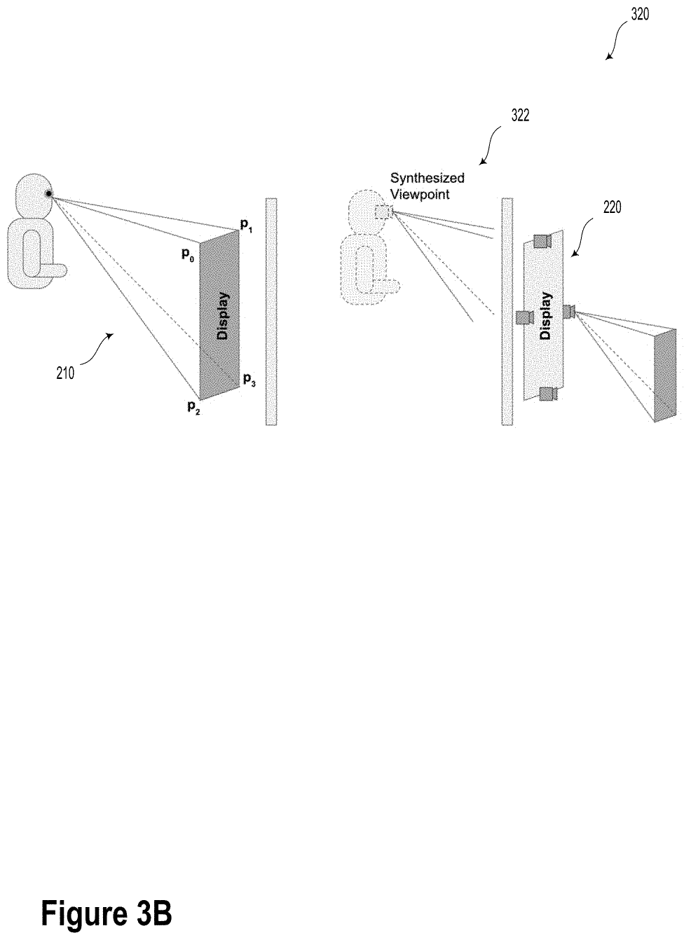

FIG. 3A illustrates a system 300, according to an example embodiment. System 300 could be similar or identical to system 200. FIG. 3A illustrates the information flow of how a viewer of viewing window 210 at Side A may observe the environment of viewing window 220 at Side B. A VTW system 300 may include a simultaneous, bi-directional information flow, so that participants on both sides can see, and interact with, each other in real time.

The computer system on each side detects and tracks the viewer's eyes via the camera or a separate image sensor. For example, the camera (e.g., the wide-angle or PTZ camera) could be used for the dual purposes of: 1) capturing image frames of an environment of a user; and 2) based on the captured image frames, detecting a position of the user's eye(s) for viewport estimation. Additionally or alternatively, in an example embodiment, the separate image sensor could be configured to provide information indicative of a location of the viewer's eyes and/or their gaze angle from that location. Based on a relative position of the display and viewer's eye position and/or gaze angle from a first location, the computer system can determine the viewport that should be captured by the camera at the second location.

On each side, before runtime, a computer system may receive and/or determine various intrinsic and extrinsic camera calibration parameters (e.g., camera field of view, camera optical axis, etc.). The computer system may also receive and/or determine the display size, orientation, and position relative to the camera. At runtime, the computer system detects and tracks the viewer's eyes via the camera or another image sensor. Based on the display position and the eye position, the computer system determines the viewport that should be captured by the camera at the other location.

On each side of the VTW system, the computer system obtains real-time viewport information received from the opposing location. Then, the viewport information is applied to the wide angle camera (and/or images captured by the wide angle camera) and a corresponding region from the wide angle images is projected into a rectangle that corresponds to the aspect ratio of the display at the other location. The captured frame is then transmitted to the other location and displayed on the display on that side. This provides an experience of “seeing through” the display, as if the viewer's eyes are located at the position of the camera on the other side.

FIG. 3B illustrates a system 320, according to an example embodiment. System 320 includes a viewing window 220 with multiple cameras. Upon receiving the real-time viewport information, the system 320 may return a view from a single wide-angle camera as described in previous examples. Additionally or alternatively, upon receiving the real-time viewport information, the system 320 may provide a synthesized view based on image information from the multiple cameras and their respective fields of view. For example, as illustrated in FIG. 3B, system 320 may provide a synthesized view based on four cameras located along the top, bottom, left, and right sides of the remote display of viewing window 220. In such a scenario, the display of viewing window 210 could provide the synthesized view to the viewer. In some embodiments, the synthesized view provided to the viewer may appear to be from a camera located at the center of the viewing window 220, elsewhere within the display area of the remote display, or at another location.

As described elsewhere herein, a view interpolation algorithm may be used to provide a synthesized view from a particular virtual view point (e.g., the center of the remote display) using image information from the multiple camera views and/or based on the cameras' relative spatial arrangement. The view interpolation algorithm could include a stereo vision interpolation algorithm, a pixel segmentation/reconstruction algorithm, or another type of multiple camera interpolation algorithm.

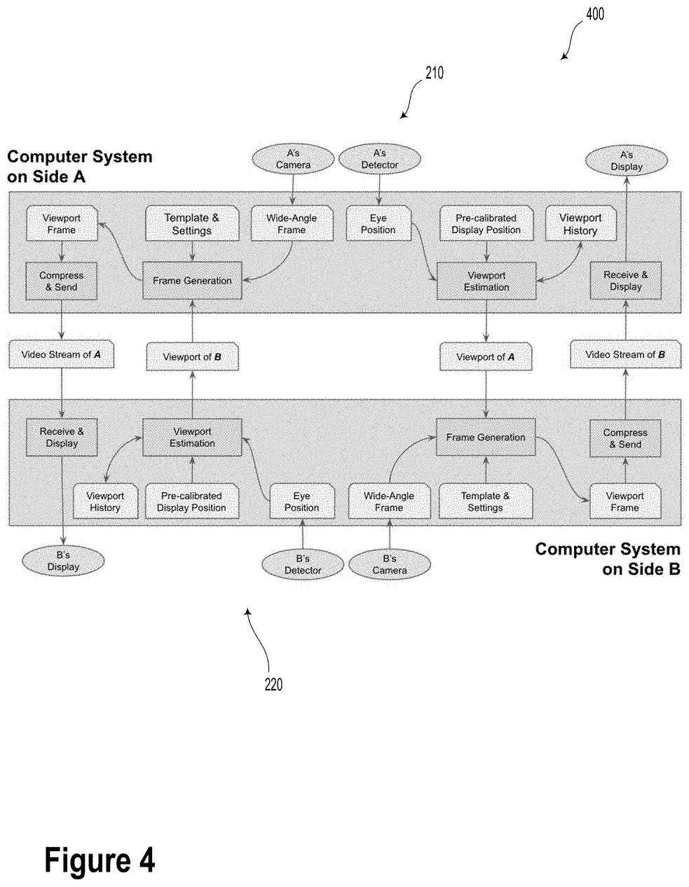

FIG. 4 is a diagram of an information flow 400, according to an example embodiment. Information flow 400 includes a VTW system (e.g., system 200 as illustrated and described with reference to FIG. 2), with different portions of the system (e.g., viewing window 210 and viewing window 220) respectively located at Side A (on the top) and Side B (on the bottom). In an example embodiment, system 200 and information flow 400 could reflect a symmetric structure, where the viewing window 110 on Side A and the viewing window 120 on Side B could be similar or identical. The respective viewing windows 110 and 120 communicate viewport information and video stream information in real-time.

Each VTW system includes at least three sub-systems, the Viewport Estimation Sub-System (VESS), the Frame Generation Sub-System, and the Streaming Sub-System.

The Viewport Estimation Sub-System receives the viewer's eye position (e.g., a position of one eye, both eyes, or an average position) from an image sensor. The VESS determines a current viewport by combining viewport history information and display position calibration information. The viewport history information could include a running log of past viewport interactions. The log could include, among other possibilities, information about a given user's eye position with respect to the viewing window and/or image sensor, user preferences, typical user eye movements, eye movement range, etc. Retaining such information about such previous interactions can be beneficial to reduce latency, image/frame smoothness, and/or higher precision viewport estimation for interactions by a given user with a given viewport. The basic concept of viewport determination is illustrated in FIG. 3A. A detailed estimation algorithm is described below.

The Frame Generation Sub-System receives image information (e.g., full wide-angle frames) from the camera at the corresponding/opposing viewport. The received information may be cropped and projected into a target viewport frame. Certain templates and settings may be applied in the process. For example, when the viewing angle is very large (e.g., even larger than the camera field of view), the projection could be distorted in a way to provide a more comfortable and/or realistic viewing/interaction experience. Furthermore, various effects could be applied to the image information such as geometrical warping, color or contrast adjustment, object highlighting, object occlusion, etc. to provide a better viewing or interaction experience. For example, a gradient black frame may be applied to the video, so as to provide a viewing experience more like a window. Other styles of frames could be applied as well. Such modifications could be defined via templates or settings.

The Streaming Sub-System will: 1) compress the cropped and projected viewport frame and transmit it to the other side of VTW; and 2) receive compressed, cropped, and projected viewport frames from the other side of VTW, uncompress the viewport frames, and display them on the display. In some embodiments, the streaming sub-system may employ a 3rd-party software, like Zoom, WebEx, among various examples.

In some embodiments, other sub-systems are contemplated and possible. For example, a handshaking sub-system could control access to the system and methods described herein. In such a scenario, the handshaking sub-system could provide access to the system upon completion of a predetermined handshaking protocol. As an example, the handshaking protocol could include an interaction request. The interaction request could include physically touching a first viewing window (e.g., knocking as if rapping on a glass window), fingerprint recognition, voice command, hand signal, and/or facial recognition. To complete the handshaking protocol, a user at the second viewing window could accept the interaction request by physically touching the second viewing window, voice command, fingerprint recognition, hand signal, and/or facial recognition, among other possibilities. Upon completing the handshaking protocol, a communication/interaction session could be initiated between two or more viewing windows. In some embodiments, the handshaking sub-system could limit system access to predetermined users, predetermined viewing window locations, during predetermined interaction time durations, and/or during predetermined interaction time periods.

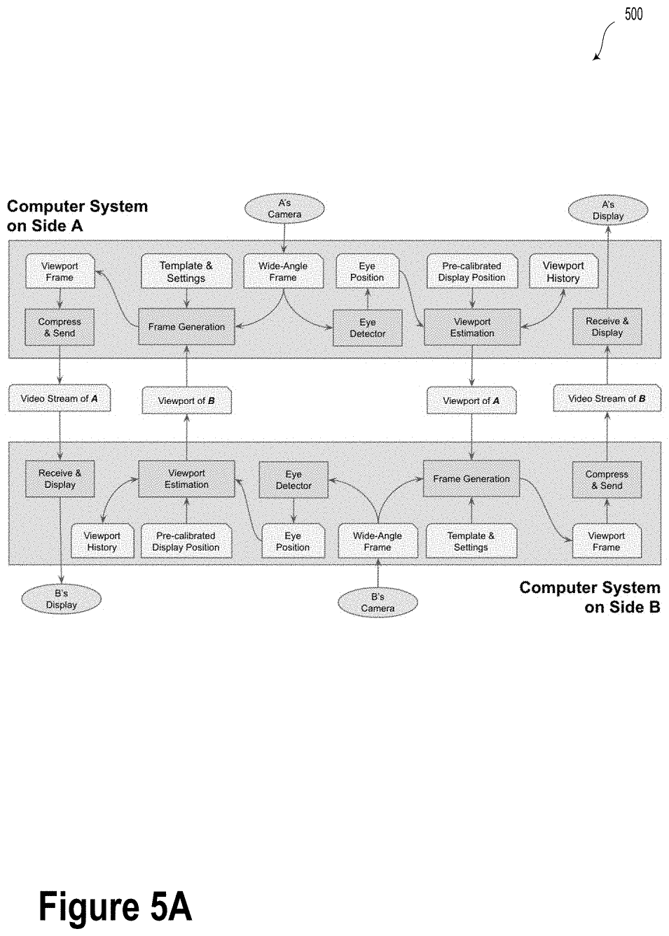

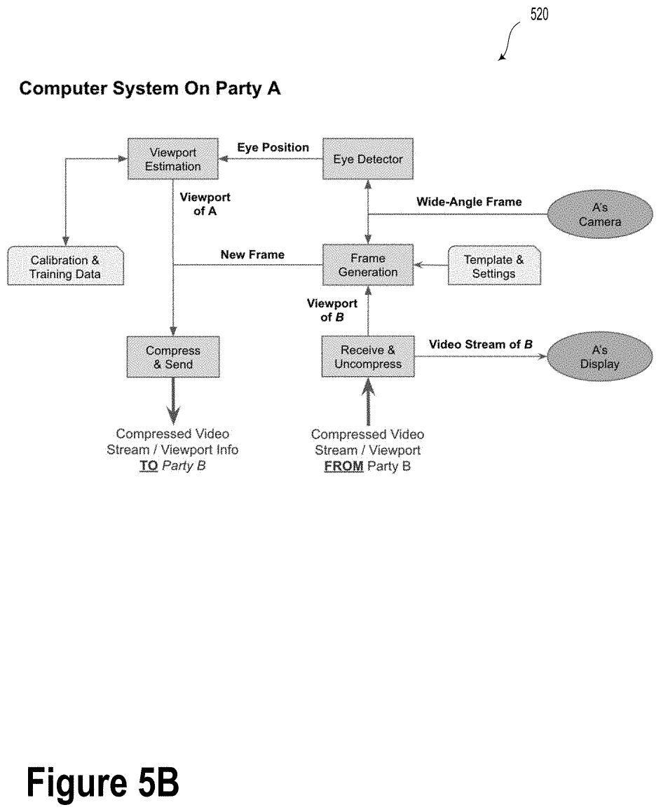

In another embodiment, a separate image sensor for eye/gaze detection need not be required. Instead, the wide-angle camera may be further utilized for eye detection. In such a scenario, the VTW system can be further simplified as shown in FIG. 5.

FIG. 5A is a diagram of an information flow 500, according to an example embodiment. In information flow 500, a separate image sensor is not needed for eye detection. In such a scenario, each viewing window of the system includes a camera and a display in addition to the computer system.

This system may also include audio channels (including mic and speaker), so that parties on both sides can not only see each other, but also talk. In some embodiments, the system could include one or more microphone and one or more speakers at each viewing window. In an example embodiment, the viewing window could include a plurality of microphones (e.g., a microphone array) and/or a speaker array (e.g., 5.1 or stereo speaker array). In some embodiments, the microphone array could be configured to capture audio signals from localized sources throughout the environment.

Furthermore, similar to the image adjustment methods and algorithms described herein, audio adjustments could be made at each viewing window to increase realism and immersion during interactions. For example, the audio provided at each viewing window could be adjusted based on a tracked position of the user interacting with the viewing window. For example, if the user located at Side A moves his or her head to view the right side portion of the environment at Side B, the viewing window at Side A may accentuate (e.g., increase the volume) of audio sources from the right side portion of the environment at Side B. In other words, the audio provided to the viewer through the speakers of the viewing window could be dynamically adjusted based on the viewport information.

FIG. 5B is a diagram of an information flow 520, according to an example embodiment. Information flow 520 and the corresponding system hardware may provide a further simplified system by combining video streaming and viewport information into one transmission channel, as illustrated. For example, viewport information can be encapsulated into frame packages or packets during video streaming. In such a scenario, the proposed system may operate as a standard USB or IP camera without specialized communication protocols.

### IV. Algorithms and Designs

A. Geometry

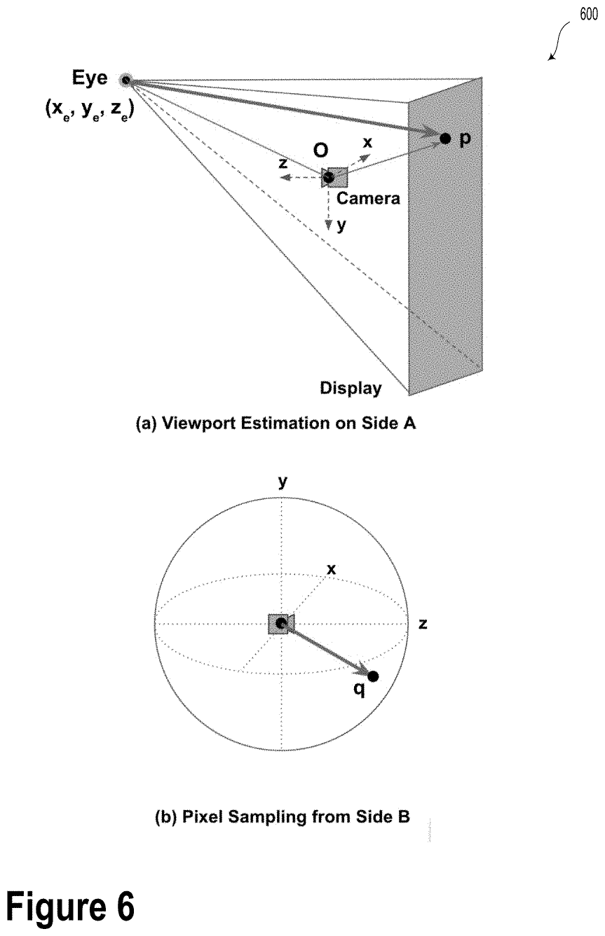

FIG. 6 illustrates a system 600, according to an example embodiment. The intensity and color of any pixel observable by a viewer on the display is captured from a camera in a different location (Side B). For every pixel p on Side A, the camera on Side B samples a pixel, q, in the same direction as the sight vector from Eye to p. This provides a see-through experience as if the eye was at the position of the camera on Side B.

On one side (Side A) of the system, let the optical center of the camera be O, the origin of the coordinate system, and the position of detected eye be (xₑ, yₑ, zₑ). We may choose the direction of the display as z axis, the downward direction as y axis. For every pixel (i, j) P on the display, we know its position as (xₚ, yₚ, zₚ) because the display position has been calibrated relative to the camera. So the vector from the Eye to Pixel (i, j) will be

EP=(xₚ,yₚ,zₚ)−(xₑ,yₑ,zₑ), (1)
and so the direction is:

Q=EP/|EP| (2)

Then, from the other side (Side B) of the system, again let the camera be the origin of the Side B coordinate system. We capture the pixel in the direction of Q=EP/|EP|, and map it to the point p in the system on Side A.

Since the system is symmetric, the same geometry applies to both directions between Side A and Side B, each of which could include similar components and/or logic. The arrangement of the display relative to the camera need not be the same at both sides. Rather, viewport estimation at the respective sides could utilize different parameters, templates, or styles. For example, a further transformation could be performed to correct for an arbitrary placement of the camera with respect to the display.

B. Calibration Data

For every pixel (i, j) P on a display, in order to determine its position in the xyz coordinate system, as explained above, a calibration is required.

In one embodiment, a calibration approach is proposed as follows, by assuming the display is a flat or cylindrical surface during calibration:
1) Input the display height H (e.g., 18″) and display width W (e.g., 32″)
2) Show a full-screen M×N checkerboard pattern of viewing areas on the display (e.g., M=32, N=18), so that the edge length of each viewing area is EdgeLength=H/N=1″ and the edge width of each rectangular area is EdgeWidth=W/M=1″;
3) Take a photo of the display using the camera. If the camera is not 360°, rotate the camera by 180° without changing its optical center, and then take a photo of the display;
4) Detect the corners of the pattern, C_{i_j}, where i=1, 2, . . . M and j=1, 2, . . . N. Let C_{1_1} be the left-top corner;
5) Let the image coordinates of C_{i_j} be (a_{i_j}, b_{i_j}, 1), where (a_{i_j}, b_{i_j}, 1) is the coordinates after rectification;

Since the camera is geometrically calibrated, the 3D vector of each corner in the xyz coordinate system:

X=(OC_{i_j})=(a_{i_j},b_{i_j},1)*z_{i_j} (3)

For an arbitrary Column i of corners, let OC_{i_1} be the first corner point. We have:

z_{i_j}=z_{i_1}+(j−1)*Δᵢ. (4)

Therefore, we have:

|OC_{i_j}−OC_{i_1}|=|(a_{i_j},b_{i_j},1)*(z_{i_1}+(j−1)*Δᵢ),(a_{i_1},b_{i_1},1)*z_{i_1})|=L, (5)
so that we can solve z_{i_1} and Δᵢ. From Equation (4), we can calculate z_{i_j}. Then, from Equation (3), we have 3D position estimation of every grid corner point.

For an arbitrary pixel on the display, (a, b) in the image coordinate system, its 3D position can be easily either via the process above, or via an interpolation from the grid.

C. Learning Data

Based on historical data obtained (e.g., transmitted, received, and/or captured) by a given viewport, regression analysis and machine learning technique may be used to predict or regularize future viewport estimations.

D. Eye Position Detector

The eye position, (xₑ, yₑ, zₑ), may be detected and tracked via the wide-angle camera, or via other image sensor. There are a number of possible eye detection techniques, which may provide (xₑ, yₑ) via camera calibration. To estimate zₑ, a separate depth camera could be utilized. Additionally or alternatively, the user depth may be estimated by way of the size of a face and/or body in the captured image of the user.

Other approaches to determining user depth and/or user position are contemplated and possible. For example, systems and methods described herein could include a depth sensor (e.g., lidar, radar, ultrasonic, or another type of spatial detection device) to determine a position of the user. Additionally or alternatively, multiple cameras, such as those illustrated and described in relation to FIG. 3B, could be utilized estimate depth via a stereo vision algorithm or similar computer vision/depth determination algorithms.

E. Viewport and its Estimation

Once the display is calibrated and eye position (xₑ, yₑ, zₑ) is captured, a sight vector from the eye to every point on the display can be calculated as shown in FIG. 6.

F. Frame Generation

Side B may transmit the entire wide-angle camera frame to Side A. Since each camera pixel on Side B is mapped to every display pixel on Side A, a frame can be generated for display. Such a scenario may not be ideal in terms of network efficiency, since only a small portion of transmitted pixels are needed for display to the user. In another example embodiment, as shown in FIGS. 4 and 5, Side A could send viewport information to Side B, and Side B could be responsible to crop and remap to a frame first, before sending it back to Side A for display. Cropping and remapping the frames prior to transmission over the network may improve latency and reduce network load due to lower resolution frames. The same technique could be applied to transmitting frames in the opposite direction (e.g., from Side A to Side B).

G. Compress and Send

New frames may be encoded as a video stream, in which we may combine (e.g., via multiplexing) audio and other information. Viewport information may be sent separately, or be packaged together with video frames transmitted to other parties.

The systems and methods described herein could involve two or more viewing locations, each of which includes a viewing window system (e.g., viewing window 210). Each viewing window includes at least a wide-angle camera (or PTZ camera), a display, and a computer system that can be communicatively coupled to a network. This system allows viewers to look into a display and feel as if they are at the position of camera in another location, yielding a see-through experience. Such a system could be termed a virtual teleport wall (VTW). When a viewer moves around, or moves closer to, or farther from, the display, he/she will observe different areas (e.g., different fields of view) from the environment of the other side of the system as if the display is a physical window. When two viewers each utilize a separate viewing window 210 and 220, they can experience an immersive interaction, seeing one another and talking to one another as if through a virtual window. With the systems and methods described herein, three dimensional images of a virtual world could be displayed as being behind, or in front of, the other participant. Such virtual world environments could be based on an actual room or environment of the other participant. In other embodiments, the virtual world environments could include information about other locations (e.g., a beach setting, a boardroom setting, an office setting, a home setting, etc.). In such scenarios, the video conference participants could view one another as being within different environments than that of reality.

### V. Example Methods

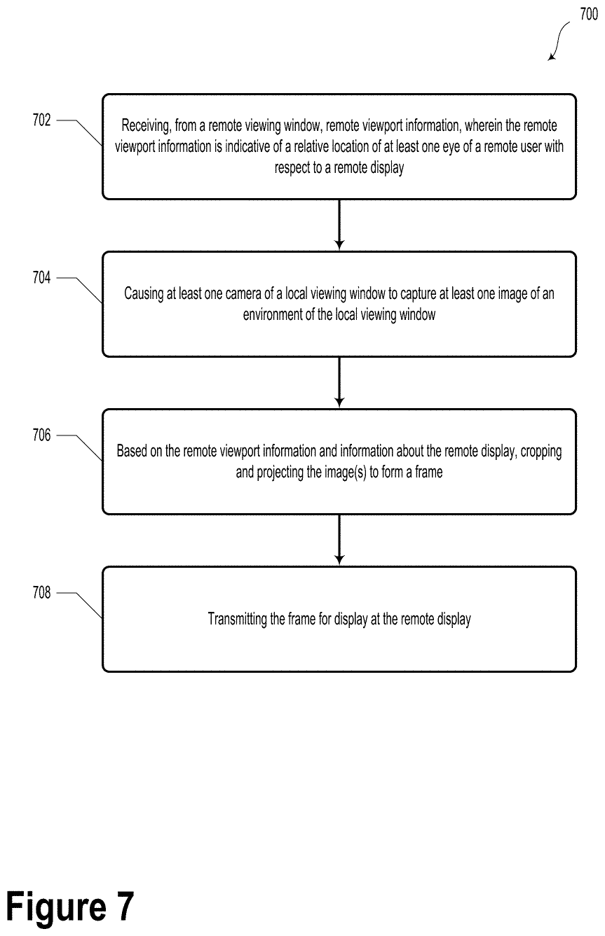

FIG. 7 illustrates a method 700, according to an example embodiment. It will be understood that the method 700 may include fewer or more steps or blocks than those expressly illustrated or otherwise disclosed herein. Furthermore, respective steps or blocks of method 700 may be performed in any order and each step or block may be performed one or more times. In some embodiments, some or all of the blocks or steps of method 700 may be carried out by system 200, system 310, or system 320 as illustrated and described in relation to FIGS. 2, 3A, and 3B, respectively.

Block 702 includes receiving, from a remote viewing window, remote viewport information. The remote viewport information is indicative of a relative location of at least one eye of a remote user with respect to a remote display.

Block 704 includes causing at least one camera of a local viewing window to capture at least one image of an environment of the local viewing window. For example, in some embodiments, block 704 could include causing a plurality of cameras of a local viewing window to capture respective images of the environment of the local viewing window.

Block 706 includes, based on the remote viewport information and information about the remote display, cropping and projecting the image(s) to form a frame. In the case of multiple cameras of the local viewing window, the formed frame could include a synthesized view. Such the synthesized view could include a field of view of the environment of the local viewing window that is different from any particular camera of the local viewing window. That is, images from multiple cameras could be combined or otherwise utilized to provide a “virtual” field of view to a remote user. In such scenarios, the virtual field of view could appear to originate from a display area of the display of the local viewing window. Other viewpoint locations and fields of view of the virtual field of view are possible and contemplated.

Block 708 includes transmitting the frame for display at the remote display.

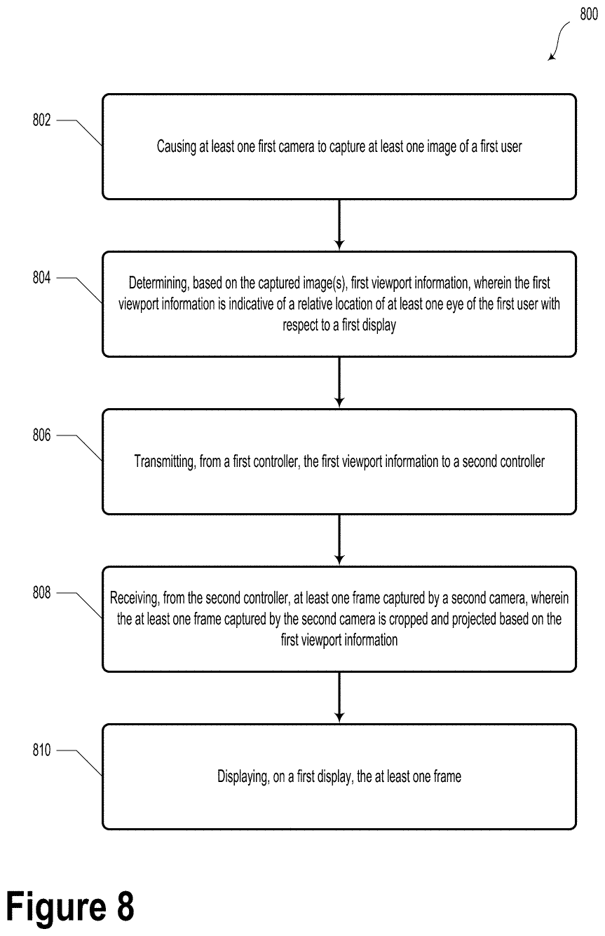

FIG. 8 illustrates a method 800, according to an example embodiment. It will be understood that the method 800 may include fewer or more steps or blocks than those expressly illustrated or otherwise disclosed herein. Furthermore, respective steps or blocks of method 800 may be performed in any order and each step or block may be performed one or more times. In some embodiments, some or all of the blocks or steps of method 800 may be carried out by system 200, system 310, or system 320 as illustrated and described in relation to FIGS. 2, 3A, and 3B, respectively.

Block 802 includes causing at least one first camera to capture an image of a first user. For example, it will be understood that one camera or multiple cameras could be utilized to capture images of the first user.

Block 804 includes determining, based on the captured image, first viewport information. The first viewport information is indicative of a relative location of at least one eye of the first user with respect to a first display. As described herein, the relative location of the first user could be determined based on a stereo vision depth algorithm or another computer vision algorithm.

Block 806 includes transmitting, from a first controller, the first viewport information to a second controller.

Block 808 includes receiving, from the second controller, at least one frame captured by at least one second camera. The at least one frame captured by the at least one second camera is cropped and projected based on the first viewport information. In some embodiments, the second camera could include multiple cameras configured to capture respective frames.

Block 810 includes displaying, on a first display, the at least one frame.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

1. A system comprising:
a local viewport comprising:
at least one camera; and
a display; and
a controller comprising at least one processor and a memory, wherein the at least one processor executes instructions stored in the memory so as to carry out operations, the operations comprising:
receiving remote viewport information, wherein the viewport information is indicative of a relative location of at least one eye of a remote user with respect to a remote display;
causing the at least one camera to capture at least one image of an environment of the local viewport;
based on the viewport information and information about the remote display, cropping and projecting the at least one image to form a frame; and
transmitting the frame for display at the remote display.

2. The system of claim 1, wherein the operations further comprise:
determining local viewport information, wherein the local viewport information is indicative of a relative location of at least one eye of a local user with respect to the display;
transmitting, to a remote controller, the local viewport information;
receiving, from the remote controller, at least one remote frame captured by a remote camera; and
displaying, on the display, the at least one remote frame.

3. The system of claim 2, wherein determining local viewport information comprises:
causing the at least one camera to capture at least one image of a local user; and
determining the local viewport information based on a location of at least one eye of the local user within the captured image(s).

4. The system of claim 2, further comprising a further image sensor, determining local viewport information comprises:
causing the further image sensor to capture an image of a local user; and
determining the local viewport information based on a location of at least one eye of the local user within the captured image.

5. The system of claim 2, wherein determining the local viewport information is further based on calibration data or training data

6. The system of claim 1, wherein transmitting the frame for display at the remote display comprises compressing the frame into a compressed video stream.

7. The system of claim 2, wherein transmitting the frame for display at the remote display comprises compressing the frame and the determined local viewport information into a compressed video stream.

8. The system of claim 1, wherein the camera comprises a wide-angle camera, a narrow-angle camera, or a pan-tilt-zoom (PTZ) camera.

9. A system comprising:
a first viewing window comprising:
at least one first camera configured to capture at least one image of a first user,
a first display; and
a first controller; and
a second viewing window comprising:
at least one second camera configured to capture at least one image of a second user,
a second display; and
a second controller, wherein the first controller and the second controller are communicatively coupled by way of a network, wherein the first controller and the second controller each comprise at least one processor and a memory, wherein the at least one processor executes instructions stored in the memory so as to carry out operations, wherein the operations comprise:
determining first viewport information based on an eye position of the first user with respect to the first display; or
determining second viewport information based on an eye position of the second user with respect to the second display.

10. The system of claim 9, wherein determining the first viewport information or the second viewport information is further based on calibration data or training data.

11. The system of claim 9, wherein the operations comprise:
causing the at least one first camera to capture at least one image of the first user, wherein determining the first viewport information is based on the captured image(s), wherein the first viewport information is indicative of a relative location of at least one eye of the first user with respect to the first display;
transmitting, to the second controller, the first viewport information;
receiving, from the second controller, at least one frame captured by the second camera; and
displaying, on the first display, the at least one frame.

12. The system of claim 9, wherein the operations comprise:
receiving, at the first controller, second viewport information, wherein the second viewport information is indicative of a relative location of at least one eye of the second user with respect to the second display;
causing the at least one first camera to capture at least one image of an environment of the first viewing window;
based on the second viewport information and information about the second display, cropping and projecting the image to form a frame; and
transmitting, to the second controller, the frame for display at the second display.

13. The system of claim 12, wherein transmitting the frame for display at the second display comprises compressing the frame into a compressed video stream.

14. The system of claim 12, wherein transmitting the frame for display at the second display comprises compressing the frame and the first viewport information into a compressed video stream.

15. A method comprising:
receiving, from a remote viewing window, remote viewport information, wherein the remote viewport information is indicative of a relative location of at least one eye of a remote user with respect to a remote display;
causing at least one camera of a local viewing window to capture at least one image of an environment of the local viewing window;
based on the remote viewport information and information about the remote display, cropping and projecting the at least one image to form a frame; and
transmitting the frame for display at the remote display.

16. The method of claim 15, wherein transmitting the frame for display at the remote display comprises compressing the frame into a compressed video stream or compressing the frame and the first viewport information into a compressed video stream.

17. The system of claim 15, wherein causing the at least one camera of the local viewing window to capture the at least one image of the environment of the local viewing window comprises causing a plurality of cameras of the local viewing window to capture a plurality of images of the environment of the local viewing window, and wherein cropping and projecting the at least one image to form the frame comprises using a view interpolation algorithm to synthesize a view from a view point based on the plurality of captured images.

18. A method comprising:
causing at least one first camera to capture at least one image of a first user;
determining, based on the captured image(s), first viewport information, wherein the first viewport information is indicative of a relative location of at least one eye of the first user with respect to a first display;
transmitting, from a first controller, the first viewport information to a second controller;
receiving, from the second controller, at least one frame captured by at least one second camera, wherein the at least one frame captured by the at least one second camera is cropped and projected based on the first viewport information; and
displaying, on a first display, the at least one frame.

19. The method of claim 18, further comprising:
receiving second viewport information from the second controller;
causing the at least one first camera to capture at least one image of an environment of the first viewing window;
based on the second viewport information and information about the second display, cropping and projecting the image(s) to form a frame; and
transmitting, to the second controller, the frame for display at the second display.

20. The system of claim 19, wherein transmitting the frame for display at the second display comprises compressing the frame and the first viewport information into a compressed video stream.
